(19) United States
(12) Patent Application Publication
(10) Pub. No.: US 2010/0207733 A1
(43) Pub. Date: Aug. 19, 2010

(54) METHOD FOR CLASSIFYING A TRANSPONDER AND/OR SIGNALS FROM A TRANSPONDER AND READER

(75) Inventor: Ulrich Muehlmann, Graz (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/679,865

(22) PCT Filed: Sep. 5, 2008
(86) PCT No.: PCT/IB08/53730

§ 371 Date: Mar. 24, 2010

(30) Foreign Application Priority Data
Sep. 26, 2007 (EP) 07117270.4

(51) Int. Cl. G06K 7/01; G06F 7/548

(52) U.S. Cl. 340/10.1; 708/440

(57) ABSTRACT

The invention discloses a method for classifying a transponder (1) and/or signals originating from a transponder (1) and a reader (20) for the inventive method. According to the invention, a reader (20) receives a signal (27, 28) from the transponder (1) and determines the the velocity (v), with which the transponder (1) is moving. Finally, the transponder (1) and/or signals (28) originating from the transponder (1) are classified as valid or invalid in response to the determined velocity (v).

### FIELD OF THE INVENTION

The invention relates to a method for classifying a transponder and/or signals originating from a transponder and to a reader.

### BACKGROUND OF THE INVENTION

Transponders, which are also referred to as tags or labels, are well known in the art and are designed to communicate with a reader which is also known as a base station. Usually, the reader sends a signal to the transponder. If the transponder is close enough to the reader, then the transponder receives this signal and may send, in response to the received signal, a response signal to the reader.

In some applications, a plurality of goods each carrying a transponder is transported as a whole, for instance, on a pallet. When passing a certain point, for instance, a door or a gate, a reader may detect the transponders. In this scenario, it is desired that the reader or a further device only processes signals received from the transponders of the plurality of goods. Particularly, if the range, within the reader can communicate with transponders, is relatively wide, then it may happen that the reader receives a response from a transponder not associated with the plurality of goods. Such transponder reader systems are, for instance, ultra high frequency (UHF) RFID transponder reader systems.

### OBJECT AND SUMMARY OF THE INVENTION

It is an object of the present invention to provide a method which allows to differentiate between signals originating from transponders associated with the plurality of goods and signals originating from further transponders.

Another object of the present invention is to provide a reader which is capable of differentiating between signals originating from transponders associated with the plurality of goods and signals originating from further transponders.

The object is achieved in accordance with the invention by means of a method for classifying a transponder and/or signals originating from a transponder, comprising the steps of:

receiving a signal from a transponder;

determining the velocity with which the transponder is moving; and

classifying the transponder and/or signals originating from the transponder as valid or invalid in response to the determined velocity.

The inventive method is particularly beneficial when discriminating transponders which are moved with a plurality of goods from other transponders in a relatively short time and in particular by means of a ultra high frequency (UHF) transponder reader system with long radio range. As the transponders associated with the moving goods (e.g. on a pallet) have all the same velocity, determination of the velocity of a transponder can be used as a property to identify transponders moved with the goods. In response to the identification based on the determined velocity, the related transponder and/or signals originating from this transponder can be classified as valid or invalid. Then, for instance, only signals originating from a valid transponder may be used for further processing. As a result, the determined velocity can be used to cluster all the transponders having the same velocity to one group and specify it as a valid group of goods detected. Signals from transponders having different velocities, for instance, originating from unwanted reads from adjacent doors or pallets standing nearby, can be clustered to another group and are specified as an invalid group of goods in, for instance, a registration (inventory) process.

In one embodiment, the inventive method further comprises classifying the transponder and/or signals originating from the transponder as valid if the determined velocity is above a first reference velocity and/or below a second reference velocity which is greater than the first reference velocity. The transponders to be detected are moving with a certain velocity. Classifying transponders and/or signals originating from the transponders as valid if the transponders move above the first reference velocity particularly allows to reject non-moving transponders, i.e. particularly allows classifying non-moving transponders and/or their signals as invalid. The first reference velocity is preferably chosen in order to reliably detecting transponders moving with the certain velocity.

Generally, the velocity of the transponder can be determined with arbitrary means. Preferably, the velocity is determined using signals sent by the transponder.

In one embodiment of the inventive method, the step of determining the velocity of the transponder comprises:

sending from the reader a first signal to the transponder;

receiving at the reader in response to the first signal a first response signal emitted by the transponder;

sending from the reader a second signal to the transponder in response to the first response signal;

receiving at the reader in response to the second signal a second response signal emitted by the transponder; and

determining the velocity of the transponder based on the time interval between the received first and second response signals.

Thus, in a further aspect of the invention, a reader comprises a sender configured to generate and send first and second signals to a transponder, and a receiver configured to receive a first response signal from the transponder in response to the first signal and to receive a second response signal from the transponder in response to the second signal, wherein the reader is configured to determine the velocity of the transponder based on the time interval between receiving the first and second response signals and based on the received first and second response signals.

The first signal sent from the reader may particularly be a query signal used to search for transponders. If the transponder is within the radio range of the reader, it receives the first signal and generates the first response signal. The first response signal may include a random number generated by and assigned to the transponder. In response to the received first response signal, the reader generates and sends the second signal which may be an acknowledge signal. In response to the second signal, the transponder generates and sends the second response signal which may, for instance, include an electronic product code (EPC) of its associated product and also a cyclic redundancy checksum that may relate to the random number. The time interval between receiving the two response signals and analyzing the two response signals can be used to determine the velocity of the transponder. The first and second response signals may be demodulated at the reader utilizing a quadrature amplitude modulated scheme so that each de-modulated first and second response signal comprises first and second components being orthogonal to each other. Then determining the velocity may include estimating the phase-shift between the two response signals and the time interval between receiving the first and second response signals.

The first and second response signals may be quadrature amplitude modulated signals each having the first and second components being orthogonal to each other. This, however, is not necessary. The transponder may also send the receiving signals utilizing, for instance, an ASK or a PSK/BPSK modulation scheme.

The phase-shift or angle, φ, between the two response signals can, for instance, be estimated as following:

φ=arctan 2(S_{Q}(t₂), S_{I}(t₂))−arctan 2(S_{Q}(t₁), S_{I}(t₁))

wherein S_{I}(t₁) is the first component of the first response signal, S_{Q}(t₁) is the second component of the first response signal, S_{I}(t₂) is the first component of the second response signal, S_{Q}(t₂) is the second component of the second response signal, and arctan 2 is the four quadrant inverse tangent function of the parts of the elements of S_{Q} and S_{I}.

Then, the velocity, v, of the transponder may be estimated according to the following equation:

$$v = \frac{{v}_{p}}{2 ω} \frac{arctan 2 ( \frac{{S}_{Q} ( {t}_{2} )}{{S}_{I} ( {t}_{2} )} ) - arctan 2 ( \frac{{S}_{Q} ( {t}_{1} )}{{S}_{I} ( {t}_{1} )} )}{{t}_{2} - {t}_{1}}$$

wherein ω is the angular carrier frequency of a carrier signal for the first and second response signals, vₚ is the propagation velocity of the carrier signal, and t₂-t₁ is the time interval between receiving the first and second response signals.

In order to improve the estimation of the velocity, at least one of the first or second components of the first or second response signals may be averaged over time.

Quadrature amplitude modulation, usually abbreviated as QAM, is known in the art per se and is a modulation scheme which conveys data by modulating the amplitude of two carrier waves. The two carrier waves are phase-shifted with respect to each other by 90° and have the same angular carrier frequency ω. Usually, the flow of bits to be transmitted is split into two parts, resulting in the generation of two independent signals to be transmitted (channels). The two independent signals are encoded separately utilizing, for instance, amplitude shift keying (ASK) or phase shift keying (PSK) modulation. One of the encoded signals is modulated by a cosine (“in-phase channel” or “I-channel”) and the other encoded signal is modulated by a sine (“quadrature channel” or “Q-channel”). Then, the two signals are added one to the other and sent through a real channel.

When utilizing a zero intermediate frequency de-modulation scheme, particularly a zero intermediate quadrature amplitude modulation scheme, then the first and second components can be described using the following equations, if the first component is “in-phase” and the second component of the second component is “quadrature”:

$${S}_{I} = cos ( \frac{2 ω d}{{v}_{p}} ) cos ( {ω}_{m} t - {φ}_{1} - \frac{{ω}_{m} d}{{v}_{p}} )$$

$${S}_{Q} = sin ( \frac{2 ω d}{{v}_{p}} ) cos ( {ω}_{m} t - {φ}_{1} - \frac{{ω}_{m} d}{{v}_{p}} )$$

wherein d is the distance form the reader to the transponder, ωₘ is the angular modulation frequency of the fundamental wave (link), φ₁ is the unknown phase shift with respect to the carrier signal, and vₚ is the propagation velocity in the related medium. The related medium is usually air. The first terms of the two components S_{I}, S_{Q} are time independent and can be treated as an additional amplitude modulation dependent on distance and wave-length. The perpendicular nature of the orthogonal IQ-channels prevents the cancellation of the base-band information in all conditions of distance and wavelength.

The additional amplitude modulation can be useful for target tracking and target velocity estimation and can help to estimate the material properties, because different materials in which the medium propagates cause different propagation velocities. Furthermore, two or more synchronized readers or one reader with specially distributed receiving antennas can be utilized for triangulation in order to achieve better localization conditions.

Since the reader knows the time instances when it receives the two response signals, the velocity, v, of the transponder can be estimated as:

$$v = \frac{Δ d}{Δ t} = \frac{{v}_{p}}{2 ω} \frac{arctan 2 ( \frac{{S}_{Q} ( {t}_{2} )}{{S}_{I} ( {t}_{2} )} ) - arctan 2 ( \frac{{S}_{Q} ( {t}_{1} )}{{S}_{I} ( {t}_{1} )} )}{{t}_{2} - {t}_{1}}$$

Δd is the distance the transponder has moved between receiving the two response signals.

The signals S_{I} and S_{Q} may be averaged to eliminate the time dependent components.

Since

$$cos ( 2 \frac{ω \cdot d}{{v}_{p}} )$$

is circular with 2π, the maximum allowed velocity of the transponder may be calculated. If using, for instance, an ultra high frequency (UHF) reader transponder system operating in accordance with the EPCglobal UHF Protocol Standard, then the system may currently operate in the range of 1 GHz. The time between receiving the two response signals in the case of the random number assigned to the transponder is currently in the range of 2 ms. Thus, the maximum velocity, vₘₐₓ, of the transponder and assuming the propagation medium is air, is approximately:

$$\frac{2 ωΔ d}{{v}_{p}} = 2 π \to {v}_{max} = \frac{Δ d}{Δ t} = \frac{1}{Δ t} = \frac{2 π {v}_{p}}{2 ω} = 75 \text{m/s}$$

The inventive method and the inventive reader can particularly be used, utilizing the transportation velocity of tags or transponders, as a distinctive feature for classification and detection of tags belonging to a group which is moved with the same velocity. Furthermore, the classification may be used to separate valid reads and invalid (unwanted) reads of the transponders.

### BRIEF DESCRIPTION OF THE DRAWINGS

The invention will be described in greater detail hereinafter, by way of non-limiting examples, with reference to the embodiments shown in the drawings.

FIG. 1 is an RFID reader transponder system,

FIG. 2 is a circuit diagram of a part of the reader of FIG. 1, and

FIG. 3 illustrates signals received by the reader.

### DESCRIPTION OF EMBODIMENTS

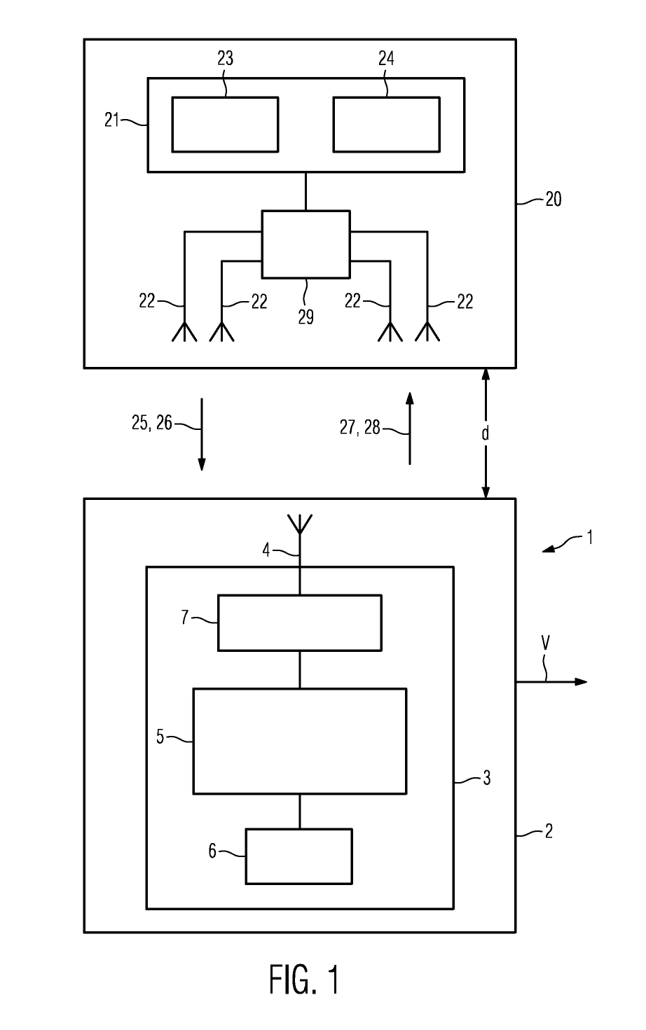

FIG. 1 shows an RFID transponder reader system. For the exemplary embodiment, the transponder reader system operates in accordance with the EPCglobal UHF Protocol Standard and can communicate with each other based on zero intermediate frequency and quadrature amplitude de-modulation (QAM).

For the exemplary embodiment, the transponder 1 is placed apart from the reader 20 at a distance d, is attached on a product not explicitly shown in the figures and is moving with the product at a velocity v. The transponder 1 comprises a substrate 2, an electric circuit which is an integrated circuit 3 for the exemplary embodiment, and an antenna 4. The integrated circuit 3 and the antenna 4 are attached to the substrate 2.

The transponder 1 is configured to receive signals sent by the reader 20 and to generate and send response signals in response to the signals of the reader 20. The response signals are ASK, PSK, BPSK or QAM signals in this embodiment and may have two components being orthogonal to each other in QAM and one component in ASK, PSK, and BPSK. Each component is modulated utilizing an ASK modulation scheme. The generation of the response signals is known per se in the art and is thus not explained in detail. In order to generate the response signals, the integrated circuit 3 of the transponder 1 may, for instance, comprise a memory 6 which stores the content of the response signal, and a micro-controller 5 connected to the memory 6 to generate the response signals.

For the exemplary embodiment, signals of the reader 20 are transmitted utilizing an UHF electro-magnetic field, as it is known per se in the art. The integrated circuit 3 further comprises a decoder/encoder stage 7 which is connected to the micro-controller 5 and to the antenna 4. The decoder/encoder stage 7 is configured to process the output signals of the antenna 4 in order to decode the reader signals from the electro-magnetic field. The decoded signals are then transferred to the micro-controller 5 for further processing. A clock signal needed for processing of the decoded signals is derived from the electro-magnetic field.

For the exemplary embodiment, the transponder 1 is a passive transponder whose integrated circuit 3 is powered by the electro-magnetic field emitted by the reader 20. However, the transponder 1 can also be an active transponder.

In this embodiment, the reader 20 comprises antennas 22, an electric circuit 21 which comprises a sender 23 and a receiver 24, and a multiplexer 29 to select an appropriate antenna of the antennas 22 when being in its sending or receiving mode. The sender 23 is configured to generate signals, in particular first and second signals 25, 26 directed to the transponder 1.

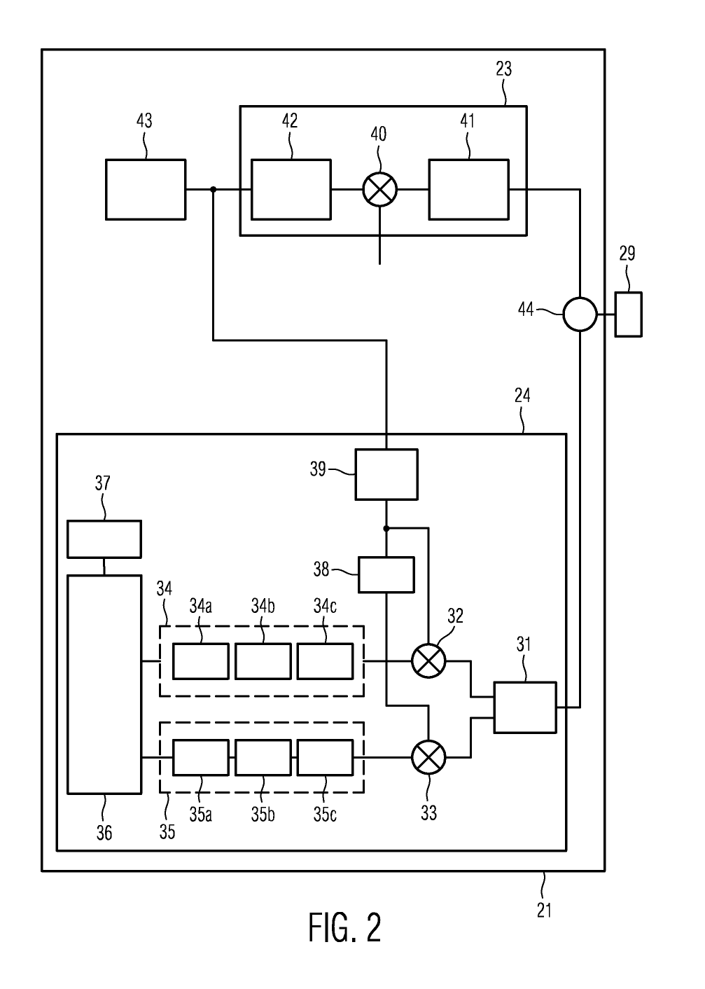

FIG. 2 shows the electric circuit 21 of the reader 20 more detailed.

For the exemplary embodiment, the electric circuit 21 comprises, besides the sender 23 and the receiver 24, a cosine wave signal generator 43 which generates a signal used as the power carrier for the electro-magnetic wave and having a carrier frequency, f, of 915 MHz, and a circulator 44. A circulator is a directional isolator and directional router dependent on the direction of outgoing and incoming signals at its individual ports. The signal generator 43 may be tunable and is connected to the sender 23 and to the receiver 24. The circulator 44 is connected to the outputs of the sender 23 and the receiver 24 and is also connected to the multiplexer 29. A multiplexer 29 is a device that switches the antennas 22 alternatively between the sender 23 and the receiver 24. The carrier frequency, f, may be fixed or variable and is not restricted to 915 MHz.

In this embodiment, the sender 23 comprises a buffer 42, a mixer 40 and a power amplifier 41. The buffer 42 is connected to the signal generator 43 and to the mixer 40. The mixer 40 modulates data on the carrier signal generated by the signal generator 43. The modulated signal is passed to the power amplifier 41 which is connected to the circulator 44. The output signal of the power amplifier 41 is transmitted by the antennas 22 to the transponder 1. For the exemplary embodiment, the modulation scheme used for the sender 23 is ASK or PR-ASK.

For the exemplary embodiment, the receiver 24 comprises a splitter 31, first and second mixers 32, 33, first and second image rejection filters 34, 35, a buffer 39, a phase-shifter 38, a microprocessor 36, and a memory 37 connected to the microprocessor 36. The image rejection filters 34, 35 are essentially identical and comprise each electro-magnetic interference (EMI) low-pass filters 34c, 35c, high-pass filters 34b, 35b, and programmable fifth order low-pass filters 34a, 35a. The buffer 39 is connected to the signal generator 43 and the phase-shifter 38 phase-shifts an input signal by 90°.

When the reader 20 receives an ASK, PSK, BPSK or QAM signal, then this signal is captured by the antenna 22 and fed via the circulator 44 to the splitter 31. The splitter 31 basically splits this signal into two identical signals. One of the split signals is fed to the first mixer 32 and the other split signal is fed to the second mixer 33. The first mixer 32 is connected to the signal generator 43 via the buffer 39. The second mixer 33 is connected to the phase-shifter 38 which is connected to the signal generator 43 via the buffer 39. Therefore, the input signals for the first mixer 32 are signals received by the reader 20 and a cosine signal having the angular carrier frequency, ω, and the input signals to the second mixer 33 are signals received by the reader 20 and a sine signal having the angular carrier frequency, ω. The output signals of the mixers 32, 33 are thus orthogonal to each other and are passed through the image rejection filters 34, 35 and processed by the microprocessor 36. The receiver 24 does not utilize any intermediate frequency for the exemplary embodiment.

When initiating a communication, the reader 20 generates and sends the first signal 25 which is a query signal for the exemplary embodiment. In response to the first signals 25, the transponder 1 generates a first response signal 27 utilizing backscattering as it is known per se in the art and sends it to the reader 20. The first response signal 27 is an ASK, PSK, BPSK or QAM signal which is based on zero intermediate frequency. The first response signal 27 may comprises a random number generated by and assigned to the transponder 1.

When the reader 20 receives the first response signal 27, it records the present time, t₁, demodulates the first response signal utilizing its mixers 32, 33, and generates and sends the second signal 26 which is an acknowledge signed for the exemplary embodiment.

Upon receiving the second signal 26, the transponder 1 demodulates and processes the second signal 26, and generates and sends a second response signal 28. For the exemplary embodiment, the second response signal 28 includes an electronic product code (EPC) of its associated product and also a cyclic redundancy checksum related to the random number.

When the reader 20 receives the second response signal 28, it records the present time, t₂, demodulates the second response signal utilizing its mixers 32, 33, and processes the information of the second response signal 28.

Since for the exemplary embodiment a zero intermediate frequency quadrature amplitude de-modulation scheme is used, the de-modulated first and second response signals 27, 28 have each two components S_{I}, S_{Q}, which can be described using the following equations, if the first component S_{I} is “in-phase” and the second component S_{Q} is “quadrature”:

$${S}_{I} = cos ( \frac{2 ω d}{{v}_{p}} ) cos ( {ω}_{m} t - {φ}_{1} - \frac{{ω}_{m} d}{{v}_{p}} )$$

$${S}_{Q} = sin ( \frac{2 ω d}{{v}_{p}} ) cos ( {ω}_{m} t - {φ}_{1} - \frac{{ω}_{m} d}{{v}_{p}} )$$

wherein d is the distance form the reader 20 to the transponder 1, ωₘ is the modulation angular frequency of the fundamental wave (link), φ₁ is the unknown phase shift with respect to the carrier signal having the angular frequency ω, and vₚ is the propagation velocity in the related medium which is air for the exemplary embodiment.

Since the transponder 1 is moving with the velocity v, the phase shift with respect to the carrier signal differs for the first and second response signals 27, 28. In order to determine the velocity v of the transponder 1, its velocity v is estimated according to the following equation:

$$v = \frac{{v}_{p}}{2 ω} \frac{arctan 2 ( \frac{{S}_{Q} ( {t}_{2} )}{{S}_{I} ( {t}_{2} )} ) - arctan 2 ( \frac{{S}_{Q} ( {t}_{1} )}{{S}_{I} ( {t}_{1} )} )}{{t}_{2} - {t}_{1}} .$$

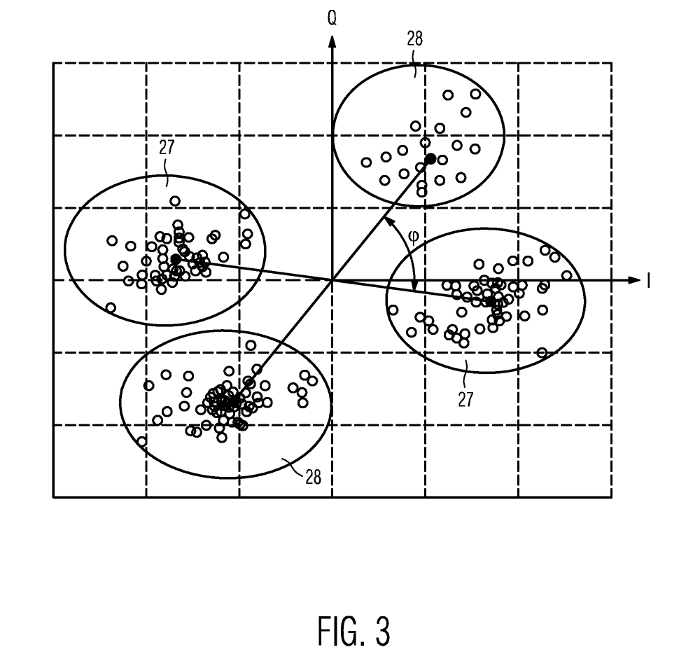

FIG. 3 illustrates the two response signals 27, 28 in the IQ-plane. Effects of amplitude variations of the response signals 27, 28 can be reduced by averaging the signals for estimation of the transponder 1 velocity v. The difference of the phase shifts with respect to the carrier signal for the first and second response signals 27, 28 is illustrated by an angle (phase-shift) φ. The angle φ can be estimated as:

$$ϕ = arctan 2 ( \frac{{S}_{Q} ( {t}_{2} )}{{S}_{I} ( {t}_{2} )} ) - arctan 2 ( \frac{{S}_{Q} ( {t}_{1} )}{{S}_{I} ( {t}_{1} )} )$$

For the exemplary embodiment, the microprocessor 36 compares the determined velocity v of the transponder 1 with a reference velocity and classifies the second response signal 28 only as valid, if the estimated velocity v of the transponder 1 is greater than the reference velocity. Otherwise, the microprocessor 36 classifies the second response signal 28 as invalid.

For the exemplary embodiment, the time instances t₁, t₂ at which the reader 20 receives the two response signals 27, 28 are stored, for instance, in the memory 37. Alternatively, it is possible to only determine the difference between these two time instances by, for instance, starting a counter at the time instance t₁.

Finally, it should be noted that the aforementioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprise” and its conjugations do not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A method for classifying a transponder and/or signals originating from a transponder, comprising the steps of:
receiving at a reader a signal from a transponder;
determining the velocity with which the transponder is moving; and
classifying the transponder and/or signals originating from the transponder as valid or invalid in response to the determined velocity.

2. The method of claim 1, comprising classifying the transponder and/or signals originating from the transponder as valid if the velocity of the transponder is above a first reference velocity and/or below a second reference velocity which is greater than the first reference velocity.

3. The method of claim 1, wherein the step of determining the velocity of the transponder comprises:
sending from the reader a first signal to the transponder;
receiving at the reader in response to the first signal a first response signal emitted by the transponder;
sending from the reader a second signal to the transponder in response to the first response signal;
receiving at the reader in response to the second signal a second response signal emitted by the transponder; and
determining the velocity of the transponder based on the time interval between the received first and second response signals.

4. The method of claim 3, comprising de-modulating the first and second response signals at the reader utilizing a quadrature amplitude modulated scheme so that each de-modulated first and second response signal comprises first and second components being orthogonal to each other, and wherein determining the velocity includes estimating the phase-shift between the two response signals and the time interval between receiving the first and second response signals.

5. The method of claim 4, comprising determining the velocity of the transponder according to the following equation:
$$v = \frac{{v}_{p}}{2 ω} \frac{arctan 2 ( \frac{{S}_{Q} ( {t}_{2} )}{{S}_{I} ( {t}_{2} )} ) - arctan 2 ( \frac{{S}_{Q} ( {t}_{1} )}{{S}_{I} ( {t}_{1} )} )}{{t}_{2} - {t}_{1}}$$
wherein v is the velocity of the transponder, ω is the angular carrier frequency of a carrier signal for the first and second response signals, vₚ is the propagation velocity of the carrier signal, t₂-t₁ is the time interval between receiving the first and second response signals, S_{I}(t₁) is the first component of the first response signal, S_{Q}(t₁) is the second component of the first response signal, S_{I}(t₂) is the first component of the second response signal, and S_{Q}(t₂) is the second component of the second response signal.

6. The method of claim 4, wherein at least one of the first or second components of the first or second response signals is averaged over time, and/or the modulation of the first and second response signals are based on zero intermediate frequency.

7. A reader, comprising:
a sender configured to generate and send first and second signals to a transponder, and a receiver configured to receive a first response signal from the transponder in response to the first signal and to receive a second response signal from the transponder in response to the second signal, wherein the reader is configured to determine the velocity of the transponder based on the time interval between receiving the first and second response signals.

8. The reader of claim 7, wherein the reader is configured to de-modulate the first and second response signals utilizing a quadrature amplitude modulated scheme so that each de-modulated first and second response signal comprises first and second components being orthogonal to each other, and the reader is configured to determine the velocity by estimating the phase-shift between the two response signals and the time interval between the received first and second response signals.

9. The reader of claim 8, further configured to determine the velocity of the transponder is calculated according to the following equation:
$$v = \frac{{v}_{p}}{2 ω} \frac{arctan 2 ( \frac{{S}_{Q} ( {t}_{2} )}{{S}_{I} ( {t}_{2} )} ) - arctan 2 ( \frac{{S}_{Q} ( {t}_{1} )}{{S}_{I} ( {t}_{1} )} )}{{t}_{2} - {t}_{1}}$$
wherein v is the velocity of the transponder, ω is the angular carrier frequency of a carrier signal for the first and second response signals, vₚ is the propagation velocity of the carrier signal, t₁-t₁ is the time interval between receiving the first and second response signals, S_{I}(t₁) is the first component of the first response signal, S_{Q}(t₁) is the second component of the first response signal, S_{I}(t₂) is the first component of the second response signal, and S_{Q}(t₂) is the second component of the second response signal.

10. The reader of claim 8, further configured to average at least one of the first or second components of the first or second response signals and/or wherein the first and second response signals are modulated on the carrier signal based on zero intermediate frequency.
